(19) United States
(12) Patent Application Publication
(10) Pub. No.: US 2009/0005012 A1
(43) Pub. Date: Jan. 1, 2009

(54) Processing a Message Received From a Mobile Cellular Network

(76) Inventor: Flemming van Heugten, Kobenhavn (DK)

Correspondence Address: HARRINGTON & SMITH, PC, 4 RESEARCH DRIVE, Suite 202, SHELTON, CT, 06484-6212, US

(21) Appl. No.: 11/666,969

(22) PCT Filed: Nov. 23, 2004
(86) PCT No.: PCT/IB04/04051

§ 371 Date: Jan. 23, 2008

(51) Int. Cl. H04M 11/10

(52) U.S. Cl. 455/413

(57) ABSTRACT

A portable radio communications device that has as a priority in an idle state an option to compose an MMS voice message, that has as a priority when an MMS voice message has been received an option to play the received voice message and that has as a priority when a received MMS voice message has been played an option to reply to the played voice message with an MMS voice message. A received message may be determined to be a voice message by comparing one or more parameters of the received message against one or more predetermined parameters that are characteristic of a voice message.

### FIELD OF THE INVENTION

Embodiments of the present invention relate to a device and method for processing a message received from a mobile cellular network.

### BACKGROUND TO THE INVENTION

At present mobile cellular telephone users have two primary ways of participating in a dialogue with another mobile telephone user. First they may have a real-time telephone conversation. This is typically achieved via a duplex telephone connection, in which both users can simultaneously speak, however, more recently it can also be achieved via a simplex Push-to-Talk connection, in which only one user can speak at a time. Second, the users may be able to alternately exchange text messages and thereby have a written dialogue.

Users may also send and receive other types of messages such as Multimedia Messaging Service (MMS) messages. However, MMS messages are typically used for sending a picture or video that records the user's environment and are not typically exchanged as part of a dialogue.

Although real-time telephone conversations remain the most popular form of having a dialogue with another user, the use of text messaging as a way of having a dialogue is also very popular particularly when the users do not want to or do not need to have a real-time dialogue.

A problem with text messaging is that a user must enter the text. Text entry is typically achieved using an ITC keypad of the mobile telephone or by selecting characters on a screen using a cursor control device. Text input can therefore be time consuming and, as mobile telephones become smaller, it becomes more difficult to use the keypad. Furthermore, some alphabets lend themselves more easily to text input than other alphabets.

It is currently technically possible to send recorded speech in a MMS message in some mobile telephones, although the process is convoluted and varies from mobile telephone to mobile telephone and is not obvious or accessible to a typical user.

FIG. 1 schematically illustrates a state diagram for one type of current mobile telephone. Five different states are illustrated: an idle state 2, a messaging application active state 4, a recording application active state 6, a playback application active state 8 and a menu navigation state 10. In order to send recorded speech in a MMS message a user must first enter the menu navigation state 10 from the idle state 2 and navigate a menu structure to initiate a sound recording application. Once the user's speech has been recorded in the recording application active state 6 it is saved into the memory of the mobile telephone. The user then re-enters the navigation state 10 and navigates the menu structure again to start an MMS messaging application. When in the messaging application active state 4, the user adds the recorded speech stored in the memory as an attachment to an MMS message.

If a user were to receive an MMS message that includes a speech recording, the user would typically have to enter the messaging application active state 4 from the menu navigation state 10, save the attached file including the voice recording to memory, re-enter the menu navigation state 10, navigate the menu to start the play-back application and then select the recorded file for playback within the playback application active state 8.

After receiving and playing an MMS message including a speech recording, a user may wish to reply to the received voice message with a voice message. However, to do this, the user will need to re-enter the navigation state 10, navigate the menu structure to initiate the sound recording application, and then, within the recording application active state 6, record speech and save it to memory. The user then re-enters the navigation state 10 and navigates the menu structure again to start an MMS messaging application. When in the messaging application active state 4, the user adds the recorded speech stored in the memory as an attachment to a new MMS message.

### BRIEF DESCRIPTION OF THE INVENTION

The inventors have realized that the problems associated with text messaging could be overcome by enabling voice messaging, in which instead of exchanging text messages users exchange messages containing recorded speech.

The inventors have also realized that only extremely well informed and competent users who have a good understanding of the menu structure of a mobile telephone and its functionality could be able to perform the complex series of sequential tasks necessary to send an MMS message including a voice recording or to play a voice recording included in a received MMS message.

The inventors have realized that it would be desirable to provide a convenient way for using voice messages in a dialogue. In particular it would be desirable to make technical alterations to the workings of a mobile telephone so that it has a user interface that is more conveniently used to send voice messages, receive and play voice messages and to reply to a voice message with a voice message.

According to one embodiment of the invention there is provided a portable radio communications device operable to enable a dialogue of voice messages, comprising: a radio transceiver for receiving a first voice message and sending a second voice message recorded at the device in reply to the first voice message, a display; one or more keys associated with the display wherein actuation of a key selects an option displayed adjacent the key in the display; a speaker for playing back the first voice message; a microphone for recording the second voice message; and display control means operable, immediately after the receipt of the first voice message, to control the display to present as a priority for user selection a first option that, on selection, changes the state of the device to a playback state for playing back the first voice message, operable, after playback of the first voice message, to control the display to present as a priority for user selection a second option that, on selection, changes the state of the device to a record state for recording the second voice message in reply to the received first voice message, and operable, after recording the second voice message, to control the display to present as a priority for user selection a third option that, on selection, changes the state of the device to a send state for sending the recorded second voice message in reply to the received first voice message.

According to another embodiment of the invention there is provided a method of operating a portable radio communications device to enable a dialogue of voice messages comprising: receiving a first voice message and immediately presenting as a priority for user selection a first option that, on selection, changes the state of the device to a playback state for playing back the first voice message; playing back the first voice message; presenting as a priority for user selection a second option that, on selection, changes the state of the device to a record state for recording a second voice message in reply to the received first voice message; recording a second voice message; presenting as a priority for user selection a third option that, on selection, changes the state of the telephone to a send state for sending the recorded second voice message in reply to the received first voice message; and sending the recorded second voice message in reply to the first voice message.

According to another embodiment of the invention there is provided a portable radio communications device comprising: means for presenting, when the device is in an idle mode, as a priority for user selection, an option that, on selection, changes the state of the device to a record state for recording a voice message; and a radio transceiver for transmitting the recorded voice message.

According to another embodiment of the invention there is provided a method of operating a portable radio communications device to initiate a dialogue using voice messages comprising: presenting, when the device is in an idle mode, as a priority for user selection an option that, on selection, changes the state of the device to a record state for recording a voice message; presenting an option for recording a voice message; and after recording of the voice message presenting an option for transmitting the recorded voice message.

According to another embodiment of the invention there is provided a method of increasing the use of MMS messaging in a mobile cellular telephone network comprising: providing mobile telephones that have as a priority in an idle state an option to compose an MMS voice message, that have as priority when an MMS voice message has been received an option to play the received voice message and that have as a priority when a received MMS voice message has been played an option to reply to the played voice message with an MMS voice message.

In this way, embodiments of the invention may provide for a non real-time dialogue based upon the exchange of voice messages. Such a dialogue is particularly useful for users who have a character based alphabet so that text entry is difficult or who are illiterate.

A voice message may be a MMS message including, as content, only recorded speech.

### BRIEF DESCRIPTION OF THE DRAWINGS

For a better understanding of the present invention reference will now be made by way of example only to the accompanying drawings in which:

FIG. 1 schematically illustrates a state diagram for one type of current mobile telephone

FIG. 2 schematically illustrates the components of a mobile telephone according to an embodiment of the invention;

FIG. 3 schematically illustrates a front face of a mobile telephone according to an embodiment of the invention;

FIG. 4 schematically illustrates a state diagram for a mobile telephone according to an embodiment of the invention;

FIG. 5 illustrates the changing content of the display of the mobile telephone while a first voice message is received, a second voice message is recorded in reply and the second voice message is sent in reply; and

FIG. 6 illustrates the changing content of the display of the mobile telephone while a voice message is composed and sent.

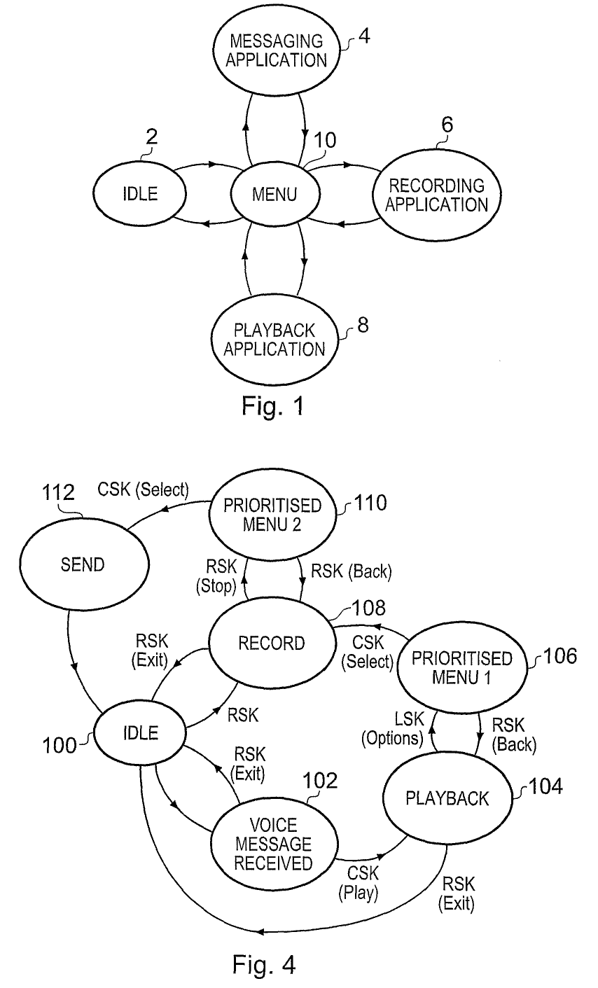

### DETAILED DESCRIPTION OF EMBODIMENTS OF THE INVENTION

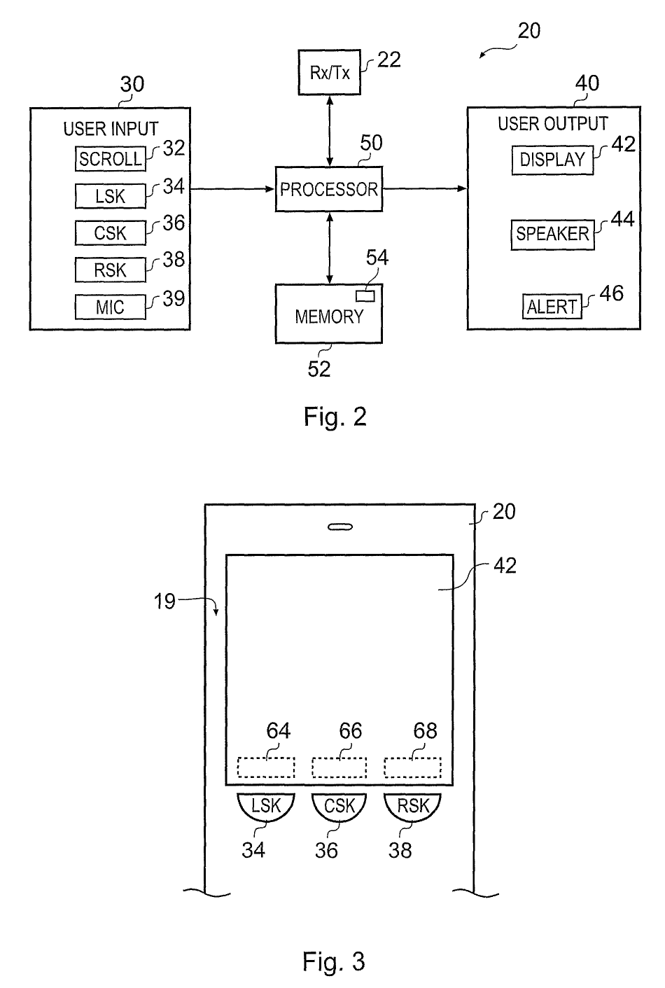

FIG. 2 schematically illustrates the components of a mobile telephone 20 according to an embodiment of the invention. The mobile telephone 20 comprises radio transceiver 22, user input devices 30, a processor 50, a memory 52 and user output devices 40. The processor 50 is connected to read from and write to the memory 52, it receives input data from the user input devices 30 and the radio transceiver 22 and provides output data to the radio transceiver 22 and the output devices 40. Computer program instructions 54 stored in the memory 52, when loaded into the processor 50, enable the processor 50 to control the operation of the mobile telephone 20. The computer program instructions 54 provide the logic and routines that enable the mobile telephone 20 to perform as illustrated in FIGS. 4, 5 and 6. The computer program instructions 54 may arrive at the mobile telephone 20 via an electromagnetic carrier signal or be copied from a physical entity such as a computer program product, a memory device or a record medium such as a CD-ROM or DVD.

The user output devices 40 include a display 42 for displaying information to a user, a speaker 44 for providing audio output to the user and an alert 46 for providing an audible or vibratory alert to the user.

The user input devices include a microphone 39 for capturing and recording speech from the user and a number of control keys. The control keys include three programmable ‘software’ keys 34, 36 and 38 and scroll keys 32 for scrolling a displayed menu.

FIG. 3 schematically illustrates a front face 19 of the mobile telephone 20. A left hand side programmable software key (LSK) 34 is positioned adjacent a lower left-hand side portion of the display 42. The function of the LSK 34 is identified by text or a graphical icon in a legend 64 displayed within the lower left side portion of the display 42. The function of the LSK 34 is programmable, in that its function and legend 64 may change with a change in the state of the mobile telephone 20. A central programmable software key (CSK) 36 is positioned adjacent a lower central portion of the display 42. The function of the CSK 36 is identified by text or a graphical icon in a legend 66 displayed within the lower central portion of the display 42. The function of the CSK 36 is programmable, in that its function and legend 66 may change with a change in the state of the mobile telephone 20. A right-hand side programmable software key (RSK) 38 is positioned adjacent a lower right-hand side portion of the display 42. The function of the RSK 38 is identified by text or a graphical icon in a legend 68 displayed within the lower right-hand side portion of the display 42. The function of the RSK 38 is programmable, in that its function and legend 64 may change with a change in the state of the mobile telephone 20. Although three separate programmable keys 34, 36, 38 have been illustrated in this embodiment, in other embodiments a different number and configuration of programmable keys may be used.

FIG. 4 schematically illustrates a state diagram for a mobile telephone according to an embodiment of the invention.

The mobile telephone 20 has the following states:

a) an idle state 100 which is entered when the mobile telephone is powered on.
b) a voice message received state 102 which is entered automatically from the idle state 100 when a voice message is received.
c) a playback state 104 which is entered from the voice message received state when the user actuates the CSK 36.
d) a prioritized first menu state 106 which is entered from the playback state when the user actuates the LSK 34.
e) a record state 108 which is entered either from the prioritized first menu state 106 when the user selects the CSK 36 or from the idle state 100 when the user selects the RSK 38.
f) a prioritized second menu state 110 which is entered from the record state 108 when the user actuates the RSK 38.
g) a send state 112 which is entered from the prioritized second menu state 106 when the user selects the CSK 36.

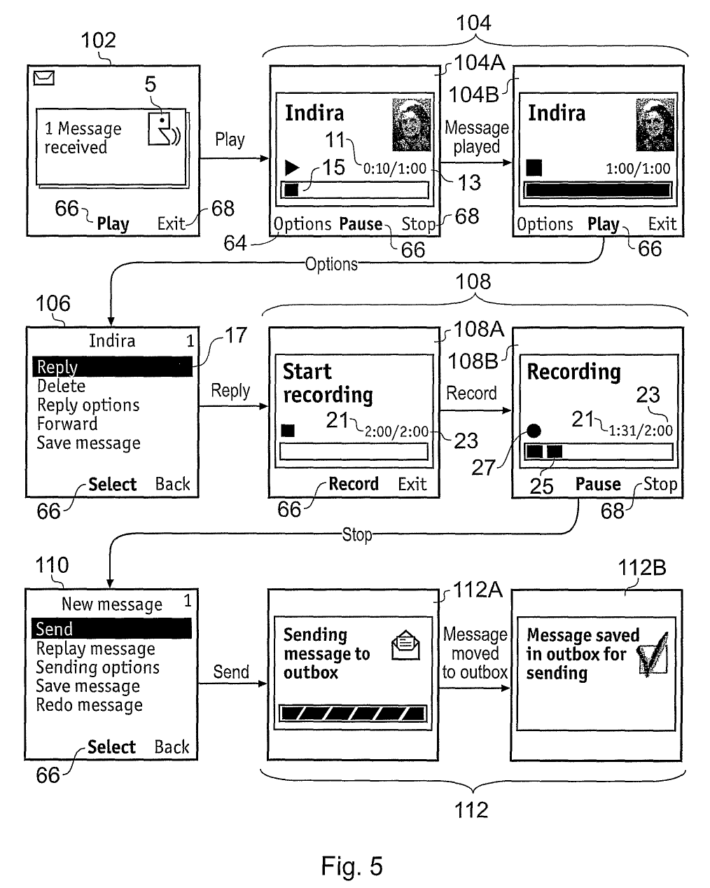

The voice message received state 102 is illustrated in FIG. 5. This state provides an indication to the user that a voice message has been received. It is entered automatically when the mobile telephone 20 determines that a message received via the radio transceiver 22 is a voice message. The display 42 displays an icon 5 indicating that a voice message has been received. The legend 66 displays the text ‘play’ and the legend 68 displays the text ‘Exit’. If the user selects the CSK 36 in this state 102, the state of the mobile telephone 20 changes to the playback state 104. If the user selects the RSK 38 in this state 102, the state of the mobile telephone 20 changes to the idle state 100.

The playback state 104 is illustrated in FIG. 5. This state plays the received voice message. Initially, in sub-state 104A the voice message is replayed while the originator of the message is identified in the display 42, in this example using a n image and text. While the message is being played displayed text 11 indicates how many seconds of the message has been played and displayed text 13 indicates the total duration of the message in seconds. A growing bar 15 also provides a graphical representation of what proportion of the message has been played. The legend 64 displays the text ‘Options’, the legend 66 displays the text ‘Pause’ and the legend 68 displays the text ‘Stop’. If the user selects the LSK 34, the state of the mobile telephone 20 changes to the prioritized first menu state 106. If the user selects the CSK 36, the playing of the message is paused and is re-started by pressing the CSK 36 again. If the user selects the RSK 38, the sub-state 104A changes to 104B. The sub-state 104A also changes to 104B when all the message has been played.

In sub-state 104B, the legend 64 displays the text ‘Options’, the legend 66 displays the text ‘Play’ and the legend 68 displays the text ‘Exit’. If the user selects the LSK 34, the state of the mobile telephone 20 changes to the prioritized first menu state 106. If the user selects the CSK 36, the mobile telephone returns to sub-state 104A and replays the voice message. If the user selects the RSK 38, the mobile telephone enters the idle state 100.

The most commonly selected option is typically associated with the CSK 66 for user convenience whereas less commonly selected options may be accessible via an options menu that is presented when, for example, the LSK 34 is actuated. In the sub-state 104B, the option ‘play’ is associated with the CSK 66 because after playing the message once the most desirable option is likely to be to re-play the message. In some embodiments, after the message has been replayed then the ‘reply’ option may be associated with the CSK 66 instead of the ‘play’ option. This is because after replaying the message the preferred option may be to reply to the replayed voice message.

In the prioritized first menu state 106, the display 42 displays a first ordered list of options: ‘Reply’, ‘Delete’, ‘Reply Options’, ‘Forward’ and ‘Save Message’. The option ‘Reply’ is the initial option in the list. On entering the prioritized first menu state 106, the initial option in the list is highlighted. Scroll keys 32 may be used to move the highlight up and down the ordered list of options. The legend 66 displays the text ‘Select’ and the legend 68 displays the text ‘Back’. If the user selects the RSK 38, the mobile telephone 20 returns to the playback state 104. If the user selects the CSK 36, the highlighted option in the list is selected. If the user selects the CSK 36 immediately after entering the prioritized first menu state 106 the mobile telephone 20 enters the record state 108. Thus entry to the record state 108 is prioritized. When the mobile telephone 20 enters the record state from the prioritized first menu state 106, the identity of the originator of the recently played voice message is saved to memory 52.

The record state has a preliminary sub-state 108A and a recording sub-state 108B. Initially, in the preliminary sub-state 108A, the user is presented with an option to start recording a voice message. The legend 66 displays the text ‘Record’ and the legend 68 displays the text ‘Exit’. If the user selects the CSK 36, the sub-state changes to recording 108B. If the user selects the RSK 38, mobile telephone 20 returns to the idle state 100.

Initially, in the recording sub-state 108B, the input to the microphone 39 is recorded in memory 52. The display includes text 21 that indicates the time available for recording the remainder of the voice message and text 23 indicates the maximum duration of a recorded voice message. A segmented growing bar 25 indicates the cost of the recorded message so far. Each segment of the growing bar represents a cost unit for the user. An icon 27 indicates that recording is in process. The legend 66 displays the text ‘Pause’ and the legend 68 displays the text ‘Stop’. If the user selects the CSK 36, the recording of the voice message is paused and is re-started by pressing the CSK 36 again. If the user selects the RSK 38, the state of the mobile telephone 20 changes to the prioritized second menu state 110.

In the prioritized second menu state 110, the display 42 displays a second ordered list of options: ‘Send’, ‘Replay Message’, ‘Sending Options’, ‘Save Message’ and ‘Redo Message’. The option ‘Send’ is the initial option in the list. On entering the prioritized second menu state 110, the initial option in the list is highlighted. Scroll keys 32 may be used to move the highlight up and down the ordered list of options. The legend 66 displays the text ‘Select’ and the legend 68 displays the text ‘Back’. If the user selects the RSK 38, the mobile telephone 20 returns to the record state 108.

If the user selects the CSK 36, the highlighted option in the list is selected. If the user selects the CSK 36 immediately after entering the prioritized second menu state 110 the mobile telephone 20 enters the send state 112. Thus entry to the send state 112 is prioritized.

In the send state 112, the reply voice message is addressed automatically using the originator's identity previously saved to the memory 52. When the voice message has been sent in reply the mobile telephone 20 enters the idle state 100.

After a voice message has been received and the mobile telephone is in the voice message received state 102 the received voice message can simply be played by actuating the CSK 36 (Play). A reply voice message can simply be composed and sent by then actuating the LSK 34 (Options), then the CSK 36 (Select), then the CSK 36 (Record), then, optionally, the RSK 38 (Stop), and then the CSK 36 (Select).

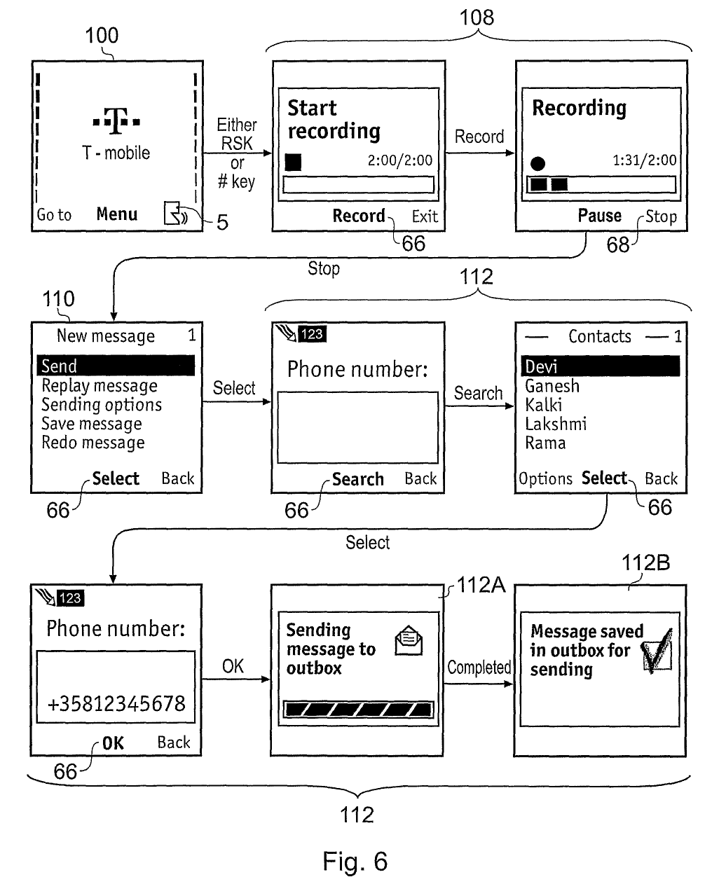

The record state 108 can also be entered from the idle state 100 as illustrated in FIG. 6. FIG. 6 illustrates the changing content of the display 42 of the mobile telephone 20 while a voice message is composed and sent. In the idle state 100, the legend 68 displays an audio message icon 5. If the user actuates the RSK 38 the mobile telephone enters the record state 108. Thus entry to the record state 108 is prioritized from the idle state 100. It may also or alternatively be possible to provide a keystroke shortcut for entering the record state 108 from the idle state 100. For example, a key on the ITU keypad of the mobile telephone such as the # key may be used. The processes of sending a message is as described above in relation to FIG. 5. The voice message is composed in the record state 108, the user selects ‘send’ in the prioritized second menu state 110. In the send state 112, however, the user needs to explicitly address the composed voice message as it is not a message in reply.

It will be appreciated that a user can compose and send a voice message from the idle state 100 simply by selecting RSK 38, then CSK 36, then RSK 38, then CSK 36 and then addressing the voice message.

Any suitable bearer may be used to transmit voice messages. However, it is expected that the invention will initially be implemented using MMS messages that include as their content only recorded speech.

The memory 52 stores predetermined parameters that are characteristic of a voice message. These are parameters that are used by all voice messages and can be used to discriminate a voice message from another MMS message. For example, the predetermined parameters may specify features of the audio encoding performed to encode a voice message and/or the audio decoding performed to play a voice message. Such features may include the type of codec used, the quality used and the format. The predetermined parameter(s) may alternatively or additionally specify whether the received message includes or does not include user composed text. A voice message does not include user composed text.

The mobile telephone discriminates received messages by comparing one or more parameters of the received message against one or more predetermined parameters that are characteristic of a voice message. If the one or more parameters of the received message match the stored predetermined parameter(s) then it can be determined that the received message is a voice message.

If the mobile telephone 20 determines that a received message is a voice message it enters the voice message received state 102. If the mobile telephone 20 determines that a received message is not a voice message it enters the MMS message received state (not shown). This is similar to the voice message received state 102 except that no voice message icon 5 is displayed and the text of the legend 66 is ‘View’ instead of play.

Although embodiments of the present invention have been described in the preceding paragraphs with reference to various examples, it should be appreciated that modifications to the examples given can be made without departing from the scope of the invention as claimed. For example, although in the above described embodiments a mobile cellular telephone has been described, it will be apparent to a person skilled in the art that the invention may be used in any portable radio communications device.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A portable radio communications device comprising:
a radio transceiver for receiving a message;
a user input device;
comparison means for comparing one or more parameters of the received message against one or more predetermined parameters that are characteristic of a voice message to determine whether the received message is a voice message; and
means responsive to the single actuation of the user input device, when the received message is determined to be a voice message, to play the received voice message.

2. A device as claimed in claim 1, wherein the one or more predetermined parameters include one or more encoding parameters that relate to the audio encoding used to encode speech included with the voice message.

3. A device as claimed in claim 1, wherein the one or more predetermined parameters indicate an absence of text within the message.

4. A device as claimed in claim 1, further comprising a display wherein the user input device is a programmable key and the display displays a legend for the programmable key that is dependent upon the type of message received.

5. A device as claimed in claim 4, wherein the display is for displaying an icon representative of a voice message when the comparison means determines that the received message is a voice message.

6. A device as claimed in claim 5, wherein the display is operable to display an indication of the origin of the received message in addition to the icon.

7. A message stored in a database of a cellular telephone network for transmission to a mobile terminal of the network, the message comprising one or more predetermined parameters that characterize the message as a voice message whereby the terminal on receipt of the message can use the one or more parameters of the received message to identify the message as a voice message and enable the immediate playing of the received voice message.

8. A method for processing at a mobile cellular terminal a message received from a mobile cellular network comprising:
receiving at the terminal a message from the mobile cellular network;
determining at the terminal whether the received message is a voice message by comparing one or more parameters of the received message against one or more predetermined parameters that are characteristic of a voice message; and
if the received message is a voice message, entering a state of the terminal in which the voice message may be directly played at the terminal by a single actuation of a user input device.

9. A method as claimed in claim 8, wherein the one or more predetermined parameters include one or more encoding parameters that relate to the audio encoding used to encode speech included with the voice message.

10. A method as claimed in claim 8, wherein the one or more predetermined parameters indicate an absence of text within the message.

11. A method as claimed in claim 8, wherein a voice message is an MMS message including, as content, only recorded speech.

12. A computer program comprising program instructions for controlling a portable radio communications device and comprising:
comparison means for comparing one or more parameters of a message received at the portable radio communications device against one or more predetermined parameters that are characteristic of a voice message to determine whether the received message is a voice message; and
means for changing a state of the portable radio communications device when the received message is determined to be a voice message, such that the device responds to a single actuation of a user input device by playing the received voice message.

13. A computer program comprising program instructions for causing a computer to perform the method of claim 8.

14. A computer program comprising program instructions which, when loaded into a computer, constitute the comparison means of claim 1.

15. A physical entity embodying the computer program as claimed in claim 12.

16. An electromagnetic carrier signal carrying the computer program as claimed in claim 12.

17. A portable radio communications device operable to enable a dialogue of voice messages, comprising:
a radio transceiver for receiving a first voice message and sending a second voice message recorded at the device in reply to the first voice message,
a display;
one or more keys associated with the display wherein actuation of a key selects an option displayed adjacent the key in the display;
a speaker for playing back the first voice message;
a microphone for recording the second voice message; and
display control means operable, immediately after the receipt of the first voice message, to control the display to present as a priority for user selection a first option that, on selection, changes the state of the device to a playback state for playing back the first voice message, operable, after playback of the first voice message, to control the display to present as a priority for user selection a second option that, on selection, changes the state of the device to a record state for recording the second voice message in reply to the received first voice message, and operable, after recording the second voice message, to control the display to present as a priority for user selection a third option that, on selection, changes the state of the device to a send state for sending the recorded second voice message in reply to the received first voice message.

18. A device as claimed in claim 17, wherein an option that is presented as a priority for user selection is selectable by a single actuation of a key.

19. A device as claimed in claim 17, wherein the first option is identified by a legend automatically displayed for a first programmable key after receipt of the first voice message.

20. A device as claimed in claim 19, wherein the legend is ‘play’.

21. A device as claimed in claim 19, wherein the device is arranged to automatically and immediately initiate playback of the first voice message when the state of the device changes to the playback state.

22. A device as claimed in any one of claim 17, wherein the display control means is automatically operable, after playback of the first voice message, to control the display to present as a priority for user selection a first menu option that, on selection, displays a first menu of options wherein the second option is identified by a highlighted initial entry in the displayed first menu of options and is selected by actuating a first programmable key.

23. A device as claimed in claim 22, wherein the first programmable key has an associated legend displayed on the display and the legend is ‘select’ while the first menu is displayed.

24. A device as claimed in claim 22, wherein the device is arranged, on changing the state of the device to the record state, to present as a priority for user selection a fourth option that, on selection, initiates recording of the second voice message.

25. A device as claimed in claim 24, wherein the fourth option is identified by a legend displayed for a first programmable key.

26. A device as claimed in claim 17, wherein the display control means is automatically operable, after recording the second voice message, to control the display to present as a priority for user selection a second menu option that, on selection, displays a second menu of options wherein the third option is identified by a highlighted initial entry in the displayed second menu of options and is selected by actuating a first programmable key.

27. A device as claimed in claim 26, wherein the first programmable key has an associated legend displayed on the display and the legend is ‘select’ while the second menu is displayed.

28. A device as claimed in claim 17, further comprising means for determining whether a received message is a voice message by comparing one or more parameters of the received first message against one or more predetermined parameters that characterize a voice message.

29. A device as claimed in claim 17, wherein each of the first and second voice messages are an MMS message including, as content, only recorded speech.

30. A method of operating a portable radio communications device to enable a dialogue of voice messages comprising:
receiving a first voice message and immediately presenting as a priority for user selection a first option that, on selection, changes the state of the device to a playback state for playing back the first voice message;
playing back the first voice message;
presenting as a priority for user selection a second option that, on selection, changes the state of the device to a record state for recording a second voice message in reply to the received first voice message;
recording a second voice message;
presenting as a priority for user selection a third option that, on selection, changes the state of the telephone to a send state for sending the recorded second voice message in reply to the received first voice message; and
sending the recorded second voice message in reply to the first voice message.

31. A method as claimed in claim 30, further comprising determining whether a received message is a voice message by comparing one or more parameters of the received message against one or more predetermined parameters that characterize a voice message.

32. A computer program comprising program instructions for controlling a portable radio communications device and comprising:
first control means operable, immediately after receipt of a first voice message at the device, to control a display of the device to present as a priority for user selection a first option that, on selection, changes a state of the device to a playback state for playing back the first voice message;
second control means operable, after playback of the first voice message, to control the display to present as a priority for user selection a second option that, on selection, changes the state of the device to a record state for recording a second voice message in reply to the received first voice message; and
third control means operable, after recording the second voice message, to control the display to present as a priority for user selection a third option that, on selection, changes the state of the device to a send state for sending the recorded second voice message in reply to the received first voice message.

33. A computer program comprising program instructions for causing a computer to perform the method of claim 30.

34. A computer program comprising program instructions which, when loaded into a computer, constitute the display control means of claim 17.

35. A physical entity embodying the computer program as claimed in claim 32.

36. An electromagnetic carrier signal carrying the computer program as claimed in claim 32.

37. A portable radio communications device comprising:
means for presenting, when the device is in an idle mode, as a priority for user selection, an option that, on selection, changes the state of the device to a record state for recording a voice message; and
a radio transceiver for transmitting the recorded voice message.

38. A device as claimed in claim 37, wherein the option is identified by a legend displayed for a second programmable key.

39. A device as claimed in claims 38, wherein the device is arranged, on changing the state of the device to the record state, to present as a priority for user selection a further option that, on selection, initiates recording of the voice message.

40. A device as claimed in claim 39, wherein the further option is identified by a legend displayed for a first programmable key.

41. A device as claimed in claim 37, further comprising means for presenting, after recording the voice message, as a priority for user selection an option that, on selection, changes the state of the device to a send state for addressing and sending the recorded voice message.

42. A device as claimed in claim 37, wherein an option that is presented as a priority for user selection is selectable by a single actuation of a key.

43. A device as claimed in claim 37, wherein a voice message is an MMS message including, as content, only recorded speech.

44. A method of operating a portable radio communications device to initiate a dialogue using voice messages comprising:
presenting, when the device is in an idle mode, as a priority for user selection an option that, on selection, changes the state of the device to a record state for recording a voice message;
presenting an option for recording a voice message; and
after recording of the voice message presenting an option for transmitting the recorded voice message.

45. A computer program comprising program instructions for controlling a portable radio communications device and comprising:
control means for controlling a display of the device to present, when the device is in an idle mode, as a priority for user selection, an option that, on selection, changes the state of the device to a record state for recording a voice message.

46. A computer program comprising program instructions for causing a computer to perform the method of claim 44.

47. A physical entity embodying the computer program as claimed in claim 45.

48. An electromagnetic carrier signal carrying the computer program as claimed in claim 45.

49. A method of increasing the use of MMS messaging in a mobile cellular telephone network comprising:
providing mobile telephones that have as a priority in an idle state an option to compose an MMS voice message, that have as priority when an MMS voice message has been received an option to play the received voice message and that have as a priority when a received MMS voice message has been played an option to reply to the played voice message with an MMS voice message.
